(19) United States
(12) Patent Application Publication
(10) Pub. No.: US 2026/0201176 A1
(43) Pub. Date: Jul. 16, 2026

(54) COMPOSITE COATING AND PREPARATION METHOD THEREFOR, SILICONE RUBBER PROTECTIVE SLEEVE AND INSULATOR

(71) Applicant: EHV POWER TRANSMISSION COMPANY OF CHINA SOUTHERN POWER GRID CO., LTD, DALI BUREAU, Dali (CN)

(72) Inventors: Qiang LI, Dali (CN); Jinyun YU, Dali (CN); Youqiang QIU, Dali (CN); Xiaoxing WEI, Dali (CN); Yong SUN, Dali (CN); Shizeng LIU, Dali (CN); Junjia HE, Dali (CN); Zhihao XU, Dali (CN); Mingdong LEI, Dali (CN); Ziyou LI, Dali (CN)

(73) Assignee: EHV POWER TRANSMISSION COMPANY OF CHINA SOUTHERN POWER GRID CO., LTD, DALI BUREAU, Dali (CN)

(21) Appl. No.: 19/566,032

(22) Filed: Mar. 13, 2026

Related U.S. Application Data
(63) Continuation of application No. PCT/CN2024/090176, filed on Apr. 26, 2024.

(30) Foreign Application Priority Data
Apr. 28, 2023 (CN) 202310479747.9

(51) Int. Cl. C09D 5/16; C08K 9/06; C09C 1/04; C09C 3/12; C09D 7/40; C09D 7/62; C09D 183/04

(52) U.S. Cl. CPC C09D 5/1618; C09C 1/043; C09C 3/12; C09D 7/62; C09D 7/67; C09D 7/69; C09D 7/70; C09D 183/04; C01P 2004/03; C01P 2004/30; C01P 2004/64; C08K 9/06; C08K 2201/004; C08K 2201/011

(57) ABSTRACT

A method of preparing the composite coating includes the steps of: coating an adhesive solution on a substrate to obtain a liquid film; embedding hydrophobically modified tetrapod-shaped zinc oxide powder into a surface of the liquid film and then embedding hydrophobically modified nano metal oxide powder into the surface of the liquid film, and fully curing the liquid film to obtain a composite coating having a micro-nano structure.

### CROSS-REFERENCE TO RELATED APPLICATIONS

This application is a continuation of International Application No. PCT/CN2024/090176, filed on Apr. 26, 2024, which claims priority to Chinese Patent Application No. 202310479747.9, filed on Apr. 28, 2023, entitled “COMPOSITE COATING AND PREPARATION METHOD THEREFOR, SILICONE RUBBER PROTECTIVE SLEEVE AND INSULATOR”. All of the aforementioned applications are incorporated herein by reference in their entireties.

### TECHNICAL FIELD

The present disclosure relates to the technical field of insulators, and in particular, to a composite coating and a preparation method therefor, a silicone rubber protective sleeve and an insulator.

### BACKGROUND

An insulator is an insulating component which is installed between parts having different potentials and between a conductor and a grounded member and is capable of withstanding voltage and mechanical stress, and plays an important role in overhead transmission lines. According to different insulating materials used, insulators may be classified into porcelain insulators, glass insulators and composite insulators. Among them, a composite insulator is an insulator composed of a glass fiber resin core rod and a silicone rubber protective sleeve and sheds, and has good hydrophobicity and hydrophobicity transfer, and has been widely used in power systems.

During outdoor operation, a composite insulator is not only subjected to a long-term high electric field, but is also frequently exposed to environmental conditions such as high radiation, large temperature differences and high humidity, particularly under strong ultraviolet radiation conditions in high-altitude regions. Under such conditions, macromolecular bonds in the silicone rubber material on the surface are prone to break, resulting in aging phenomena such as loss of hydrophobicity, surface hardening and chalking, cracking and damage, and exposure of internal fillers. In addition, the loss of hydrophobicity further induces corona aging and damp heat aging on the surface of the silicone rubber, so that the composite insulator is prone to causing serious power failures such as pollution flashover, internal breakdown and brittle fracture, thereby seriously threatening the safe and reliable operation of a power grid. However, anti-aging modification of silicone rubber materials in the conventional art is not ideal, resulting in poor weather resistance of composite insulators.

### SUMMARY

In view of the foregoing, in various embodiments, the present disclosure provides a composite coating having excellent anti-aging performance, a preparation method therefor, a silicone rubber protective sleeve, and an insulator. The technical solutions are as follows.

According to a first aspect of the present disclosure, there is provided a method of preparing a composite coating, comprising:
coating an adhesive solution on a substrate to obtain a liquid film; and
embedding hydrophobically modified tetrapod-shaped zinc oxide powder into a surface of the liquid film and then embedding hydrophobically modified nano metal oxide powder into the surface of the liquid film, and fully curing the liquid film to obtain a composite coating having a micro-nano structure.

In one embodiment, the nano metal oxide powder comprises one or more of nano zinc oxide powder, nano titanium oxide powder, nano cerium oxide powder and nano iron oxide powder.

In one embodiment, the adhesive solution is a one-component room temperature vulcanized (RTV) silicone rubber adhesive solution.

In one embodiment, embedding the hydrophobically modified tetrapod-shaped zinc oxide powder into the surface of the liquid film comprises: sprinkling the hydrophobically modified tetrapod-shaped zinc oxide powder onto the surface of the liquid film, and subjecting the liquid film to a first curing at room temperature until the hydrophobically modified tetrapod-shaped zinc oxide powder is embedded while the liquid film is not fully cured; and removing the hydrophobically modified tetrapod-shaped zinc oxide powder that has not been embedded in the surface of the liquid film.

In one embodiment, the liquid film is fully cured at a temperature of 60° C. to 80° C. for 6 to 8 hours.

In one embodiment, the hydrophobically modified tetrapod-shaped zinc oxide powder and the hydrophobically modified nano metal oxide powder are prepared by a coupling modification method.

In one embodiment, a method of preparing the hydrophobically modified tetrapod-shaped zinc oxide powder comprises:
mixing tetrapod-shaped zinc oxide powder with ethanol and water to obtain a dispersion;
adding a silane coupling agent into the dispersion to obtain a mixed solution; and
adjusting a pH of the mixed solution to 7 to 9, stirring at 50° C. to 70° C. for 4 to 6 hours, and subjecting the mixed solution to solid-liquid separation to obtain the hydrophobically modified tetrapod-shaped zinc oxide powder.

In one embodiment, a method of preparing the hydrophobically modified nano metal oxide powder comprises:
mixing nano metal oxide powder with ethanol and water to obtain a dispersion;
adding a silane coupling agent into the dispersion to obtain a mixed solution; and
adjusting a pH of the mixed solution to 7 to 9, stirring at 50° C. to 70° C. for 4 to 6 hours, and subjecting the mixed solution to solid-liquid separation to obtain the hydrophobically modified nano metal oxide powder.

In one embodiment, the preparation methods of the hydrophobically modified tetrapod-shaped zinc oxide powder and the hydrophobically modified nano metal oxide powder satisfy one or more of the following conditions:
(1) the silane coupling agent is a perfluoro silane coupling agent;
(2) a mass ratio of the silane coupling agent to the tetrapod-shaped zinc oxide powder or the nano metal oxide powder is (1 to 10): 100;
(3) a concentration of the tetrapod-shaped zinc oxide powder or the nano metal oxide powder in the dispersion is 1 wt. % to 12 wt. %; and
(4) a volume ratio of the ethanol to the water is (1 to 9): 1.

In one embodiment, the composite coating satisfies one or more of the following conditions:
(1) a whisker length of the tetrapod-shaped zinc oxide powder is 10 μm to 100 μm;
(2) a particle size of the nano metal oxide powder is ≤100 nm;
(3) a mass ratio of the tetrapod-shaped zinc oxide powder to the nano metal oxide powder is 1:(1 to 5);
(4) a thickness of the liquid film is 50 μm to 70 μm; and
(5) a thickness of the composite coating is 80 μm to 100 μm.

In one embodiment, the adhesive solution comprises an adhesive and a diluent in a mass ratio of 1:(1 to 3).

In one embodiment, the substrate is one or more selected from a polymer substrate, a glass substrate, a ceramic substrate and a metal substrate.

According to a second aspect of the present disclosure, there is provided a composite coating prepared by the method of preparing the composite coating as described above.

According to a third aspect of the present disclosure, there is provided a silicone rubber protective sleeve comprising the composite coating as described above.

According to a fourth aspect of the present disclosure, there is provided an insulator comprising the silicone rubber protective sleeve as described above.

Details of one or more embodiments of the present disclosure are set forth in the description below. Other features, objects and advantages of the present disclosure will become apparent from the specification and the appended claims.

### BRIEF DESCRIPTION OF THE DRAWINGS

In order to more clearly illustrate the technical solutions of the embodiments of the present disclosure or of the prior art, brief descriptions of the drawings that are required in the description of the embodiments or the prior art are given below. It is obvious that the drawings described below are merely for illustrating some embodiments of the present disclosure. For those of ordinary skill in the art, other drawings may also be obtained based on the disclosed drawings without creative effort.

FIG. 1 is a scanning electron microscope (SEM) image of a composite coating prepared in Example 1.

FIG. 2 is a water contact angle test image of the composite coating prepared in Example 1.

FIG. 3 is an SEM image of high-temperature vulcanized (HTV) silicone rubber in Comparative Example 1.

FIG. 4 is a water contact angle test image of HTV silicone rubber in Example 1.

### DETAILED DESCRIPTION OF THE EMBODIMENTS

The technical solutions of the embodiments of the present disclosure will be clearly and completely described below with reference to the accompanying drawings of the embodiments of the present disclosure. It is to be understood that the embodiments described are merely some, but not all, embodiments of the present disclosure. All other embodiments obtained by those of ordinary skill in the art based on the embodiments of the present disclosure without creative effort fall within the scope of protection of the present disclosure.

Unless defined otherwise, all technical and scientific terms used herein have the same meaning as commonly understood by one of ordinary skill in the art to which the present disclosure pertains. The terms used in the specification of the present disclosure are only for the purpose of describing particular embodiments and are not intended to limit the present disclosure.

### Terminology

Unless otherwise specified or the context clearly indicates otherwise, the terms or phrases used herein have the following meanings.

“SEM” refers to a scanning electron microscope.

“Contact angle”, also known as wetting angle, refers to an included angle between a solid-liquid interface and a gas-liquid interface at a solid, liquid and gas three-phase contact line, the angle being measured inside the liquid phase from the solid-liquid interface to the gas-liquid interface.

“Water contact angle”, also known as a water droplet angle, is a type of contact angle, specifically referring to a contact angle formed by a water droplet on a solid surface, and can be used to characterize hydrophilicity and hydrophobicity of the solid surface. A larger water contact angle indicates stronger hydrophobicity, and a smaller water contact angle indicates stronger hydrophilicity.

“Silicone rubber” refers to a rubber whose main chain is alternately composed of silicon and oxygen atoms and whose silicon atoms are usually bonded to two organic groups. Silicone rubber may be classified according to vulcanization mechanisms into HTV silicone rubber and RTV silicone rubber. HTV rubber has outstanding electrical properties and contamination resistance and hydrophobicity, and can be used to prepare sheds and protective sleeves of composite insulators.

An aging process of a silicone rubber material is generally a result of multiple factors such as damp heat and ultraviolet acting together, whereas in the conventional art, anti-aging modification of silicone rubber is often focused only on one of the factors, such as hydrophobic modification or anti-ultraviolet modification.

Hydrophobic modification of silicone rubber materials is mainly performed by laser etching on the surface or by plasma fluorination. For example, there have been reports that a micro-nano composite hierarchical structure is constructed on the surface of HTV silicone rubber by femtosecond laser etching, thereby increasing surface roughness and forming fine papillary structures, and a stable superhydrophobic state is prepared on the surface of HTV silicone rubber. There have also been reports that CF₄ radio-frequency inductively coupled plasma and capacitively coupled plasma are respectively used to treat a surface of HTV silicone rubber, and hydrophobic modification is performed on the surface of the silicone rubber by etching and fluorination of low-temperature plasma. Although surface laser etching or plasma fluorination can improve surface hydrophobicity of silicone rubber, the two treatment methods not only have complicated processes, require expensive equipment and are difficult to apply on a large scale, but the treatment process itself also damages the surface of the silicone rubber, and internal inorganic fillers in the silicone rubber are easily exposed, thereby impairing its mechanical strength.

With respect to anti-ultraviolet radiation aging of silicone rubber, current research mainly focuses on internal modification by adding some additives or fillers having light shielding and ultraviolet absorption functions into a silicone rubber matrix. For example, there have been reports that nano titanium dioxide particles are doped into a silicone rubber matrix, and an HTV silicone rubber composite material is prepared by blending to improve anti-aging capability under ultraviolet radiation. There have been reports that an HTV silicone rubber is prepared by adding three organic ultraviolet absorbers UV-327, UV-531 and UVP-788 into the silicone rubber to improve its anti-ultraviolet aging capability. There have been reports that nano cerium dioxide particles modified by a silane coupling agent KH151 are added into an RTV matrix by blending to improve an anti-ultraviolet aging performance of an RTV silicone rubber surface. There have been reports that nano zinc oxide is introduced into an RTV matrix to prepare a composite material to improve its anti-ultraviolet aging capability. Although adding organic ultraviolet absorbers or inorganic ultraviolet shielding agents into a silicone rubber matrix can improve the anti-ultraviolet aging capability of silicone rubber to a certain extent, organic ultraviolet absorbers have poor stability, are prone to migration and may reduce mechanical strength of the matrix, whereas inorganic ultraviolet shielding agents dispersed by blending in the matrix basically do not improve surface hydrophobicity of the silicone rubber and may even cause a negative effect of reduced hydrophobicity.

Thus, in the conventional art, anti-aging modification of silicone rubber materials is either a single hydrophobic modification or a single anti-ultraviolet modification, and hydrophobic modification and anti-ultraviolet modification are not organically combined. Furthermore, optimization of one property may cause deterioration of another property, and the treatment process easily damages the surface of the silicone rubber, so that weather resistance of the silicone rubber cannot be improved through synergistic action of multiple factors. In view of the above, it is very important to develop a preparation method having a simple process, not causing surface damage, and capable of simultaneously performing hydrophobic modification and anti-ultraviolet modification to obtain a composite coating having excellent anti-aging effect, so as to achieve long-term stable operation of composite insulators under environmental conditions of high radiation, high humidity and large temperature differences.

In view of the foregoing, in the first aspect of the present disclosure, there is provided a method of preparing a composite coating, comprising:
coating an adhesive solution on a substrate to obtain a liquid film; and
embedding hydrophobically modified tetrapod-shaped zinc oxide powder into a surface of the liquid film and then embedding hydrophobically modified nano metal oxide powder into the surface of the liquid film, and fully curing the liquid film to obtain a composite coating having a micro-nano structure.

It can be understood that the method of first embedding the hydrophobically modified tetrapod-shaped zinc oxide powder into the surface of the liquid film and then embedding the hydrophobically modified nano metal oxide powder is a stepwise embedding method.

In the present disclosure, after the adhesive solution is coated on a surface of the substrate to form a liquid film, hydrophobically modified tetrapod-shaped zinc oxide powder and hydrophobically modified nano metal oxide powder are embedded stepwise into the surface of the liquid film by utilizing the characteristic that the liquid film has not been cured, and the liquid film is then fully cured, thereby obtaining a composite coating having excellent anti-aging effect.

First, the tetrapod-shaped zinc oxide powder and the nano metal oxide powder are both inorganic ultraviolet shielding agents. After they are embedded stepwise into the surface of the liquid film, a substrate material can be endowed with excellent anti-ultraviolet function by absorption, reflection and scattering. Second, the tetrapod-shaped zinc oxide powder and the nano metal oxide powder have small particle sizes and thus have large specific surface areas and high surface energies and exhibit strong hydrophilicity. Hydrophobic modification is performed on them prior to the stepwise embedding, so that they exhibit excellent hydrophobic performance and improve surface hydrophobicity of the substrate material. Furthermore, since the tetrapod-shaped zinc oxide powder is a micron-sized single-crystal powder composed of a central body and four needle-like whiskers, the nano metal oxide powder can be filled into numerous voids among whiskers of the tetrapod-shaped zinc oxide powder via the stepwise embedding method, which not only can greatly improve ultraviolet shielding, but also can form a micro-nano structure having a lotus leaf-like papillary structure, so that the composite coating attains a stable superhydrophobic state.

Further, after the stepwise embedding, the liquid film is fully cured to obtain an adhesive layer having strong adhesion, which can prevent hydrophobically modified oxide powder from falling off, significantly improve bonding fastness between the composite coating and the substrate, and enable the composite coating to exhibit long-term hydrophobicity and stable anti-ultraviolet performance, thereby obtaining excellent anti-aging effect. In addition, the liquid film formed by coating the adhesive solution on the substrate can avoid mechanical damage to the surface of the substrate caused by modification treatment, and greatly reduce negative influence on mechanical properties of the substrate.

In some embodiments, the nano metal oxide powder comprises one or more of nano zinc oxide powder, nano titanium oxide powder, nano cerium oxide powder and nano iron oxide powder.

Nano powders of metal oxides such as zinc oxide, titanium dioxide, cerium oxide and iron oxide have good ultraviolet shielding performance and can block ultraviolet intrusion through different actions such as scattering, reflection and absorption at the same time, thereby effectively improving anti-ultraviolet performance of the composite coating.

In some preferred embodiments, the nano metal oxide powder is nano zinc oxide powder.

In some embodiments, the adhesive solution is a one-component RTV silicone rubber adhesive solution.

One-component RTV silicone rubber is a power anti-pollution flashover coating, which comprises polydimethylsiloxane, a crosslinking agent, a catalyst, a solvent and other components, and has excellent electrical properties and chemical inertness. It does not absorb heat or release heat during curing, has a small shrinkage after curing, has good adhesion to various materials, and particularly has stronger adhesion to HTV silicone rubber, such that the composite coating can be firmly attached to the surface of the substrate for a long time without falling off, thereby enabling the composite coating to exhibit long-term hydrophobicity and stable anti-ultraviolet performance. At the same time, curing of the one-component RTV silicone rubber is performed by a vulcanization reaction directly occurring with moisture in air to form a thermosetting elastomer. The curing reaction can proceed slowly at room temperature, and the vulcanization process can also be accelerated by changing environmental temperature and humidity. Compared with two-component or multi-component RTV silicone rubber, the curing reaction of one-component RTV silicone rubber has stronger controllability and simpler operation, which is beneficial to smooth progress of subsequent stepwise embedding.

In some preferred embodiments, the adhesive solution is a one-component PRTV silicone rubber adhesive solution.

One-component PRTV silicone rubber is a novel electrical functional material which, compared with ordinary one-component RTV silicone rubber, has stronger adhesion, better hydrophobicity and better anti-pollution flashover effect, and can further improve comprehensive anti-aging capability of the composite coating.

In some embodiments, embedding the hydrophobically modified tetrapod-shaped zinc oxide powder into the surface of the liquid film comprises: sprinkling the hydrophobically modified tetrapod-shaped zinc oxide powder onto the surface of the liquid film, subjecting the liquid film to a first curing at room temperature until the hydrophobically modified tetrapod-shaped zinc oxide powder is embedded while the liquid film is not fully cured; and removing the hydrophobically modified tetrapod-shaped zinc oxide powder that has not been embedded in the surface of the liquid film.

After the hydrophobically modified tetrapod-shaped zinc oxide powder is sprinkled onto the surface of the liquid film, the liquid film is subjected to a first curing for a period of time at room temperature, so that whiskers of part of the tetrapod-shaped zinc oxide powder can be firmly embedded into the surface of the liquid film, and the remaining tetrapod-shaped zinc oxide powder loosely covers the surface of the liquid film. These loosely covered tetrapod-shaped zinc oxide powders are then immediately removed, thereby exposing whisker voids of the tetrapod-shaped zinc oxide powder that has been firmly bonded, which is beneficial to filling nano metal oxide powder into whiskers therebetween and embedding the nano metal oxide powder into the surface of the liquid film.

In some more preferred embodiments, the first curing time is 10 min to 20 min.

In some preferred embodiments, embedding the hydrophobically modified nano metal oxide powder into the surface of the liquid film comprises: after removing the hydrophobically modified tetrapod-shaped zinc oxide powder that has not been embedded in the surface of the liquid film, subjecting the liquid film to a second curing at room temperature while the liquid film is not fully cured; and sprinkling the hydrophobically modified nano metal oxide powder onto the surface of the liquid film.

In some more preferred embodiments, the second curing time is 5 min to 10 min.

In some preferred embodiments, after the liquid film is fully cured, the method further comprises: removing the hydrophobically modified nano metal oxide powder that has not been embedded in the surface of the liquid film.

In some embodiments, the liquid film is fully cured at a temperature of 60° C. to 80° C. for 6 to 8 hours.

The one-component RTV silicone rubber requires at least 24 hours to be fully cured at room temperature. Increasing curing temperature can shorten the curing time and is beneficial to enhancing curing depth and strength.

In some embodiments, the hydrophobically modified tetrapod-shaped zinc oxide powder and the hydrophobically modified nano metal oxide powder are prepared by a coupling modification method.

Hydrophobic modification methods for inorganic materials include a surfactant method, a polymer coating method and a coupling modification method. Among them, the surfactant method has insufficient stability and hydrophobicity is easily lost, and polymers commonly used in the polymer coating method have insufficient hydrophobicity and poor anti-ultraviolet capability, which are not conducive to hydrophobic modification of the composite coating. The coupling modification method utilizes a silane coupling agent to undergo a chemical reaction with hydroxyl groups on surfaces of inorganic particles, thereby introducing strongly hydrophobic organic groups onto surfaces of the inorganic particles to reduce surface energy. This not only can significantly improve hydrophobic performance of the inorganic particles, but can also enhance compatibility and dispersibility of the inorganic particles with the liquid film, thereby improving embedding effects of the two inorganic ultraviolet shielding agents.

In some embodiments, a method of preparing the hydrophobically modified tetrapod-shaped zinc oxide powder comprises:
mixing tetrapod-shaped zinc oxide powder with ethanol and water to obtain a dispersion;
adding a silane coupling agent into the dispersion to obtain a mixed solution; and
adjusting a pH of the mixed solution to 7 to 9, stirring at 50° C. to 70° C. for 4 to 6 hours, and subjecting the mixed solution to solid-liquid separation to obtain the hydrophobically modified tetrapod-shaped zinc oxide powder or hydrophobically modified nano metal oxide powder.

In some embodiments, a method of preparing the hydrophobically modified nano metal oxide powder comprises:
mixing nano metal oxide powder with ethanol and water to obtain a dispersion;
adding a silane coupling agent into the dispersion to obtain a mixed solution; and
adjusting a pH of the mixed solution to 7 to 9, stirring at 50° C. to 70° C. for 4 to 6 hours, and subjecting the mixed solution to solid-liquid separation to obtain the hydrophobically modified tetrapod-shaped zinc oxide powder or hydrophobically modified nano metal oxide powder.

In some preferred embodiments, adjusting the pH of the mixed solution comprises: adding one or more of sodium hydroxide, sodium carbonate, sodium bicarbonate and ammonia water into the mixed solution.

In some more preferred embodiments, the pH of the mixed solution is adjusted to 8.

In some embodiments, the method of preparing the hydrophobically modified tetrapod-shaped zinc oxide powder and the hydrophobically modified nano metal oxide powder satisfies one or more of the following conditions:
(1) the silane coupling agent is a perfluoro silane coupling agent;
(2) a mass ratio of the silane coupling agent to the tetrapod-shaped zinc oxide powder or the nano metal oxide powder is (1 to 10): 100;
(3) a concentration of the tetrapod-shaped zinc oxide powder or the nano metal oxide powder in the dispersion is 1 wt. % to 12 wt. %; and
(4) a volume ratio of the ethanol to the water is (1 to 9): 1.

Fluorine has the lowest surface energy. Therefore, when inorganic materials are modified by a perfluoro silane coupling agent, optimal hydrophobic performance can be obtained. Various parameters of the coupling modification method are adjusted, so that the tetrapod-shaped zinc oxide powder or the nano metal oxide powder attains better hydrophobic performance.

In some preferred embodiments, the volume ratio of the ethanol to the water is 9:1.

In some embodiments, the composite coating satisfies one or more of the following conditions:
(1) a whisker length of the tetrapod-shaped zinc oxide powder is 10 μm to 100 μm;
(2) a particle size of the nano metal oxide powder is ≤100 nm;
(3) a thickness of the liquid film is 50 μm to 70 μm; and
(4) a thickness of the composite coating is 80 μm to 100 μm.

It can be understood that the particle size refers to an equivalent circle diameter of a particle, that is, a diameter of a circle having a planar projection area equivalent to that of the particle.

By adjusting the whisker length of the tetrapod-shaped zinc oxide powder and the particle size of the nano metal oxide powder, it is beneficial to optimizing morphology of the micro-nano structure and improving hydrophobic performance thereof. A thickness of the liquid film greater than the whisker length of the tetrapod-shaped zinc oxide powder can enable whiskers in the tetrapod-shaped zinc oxide powder to form a more robust bonding with the liquid film and avoid mechanical damage to the substrate caused by the stepwise embedding treatment. When the thickness of the composite coating is 80 μm to 100 μm, the composite coating will not be too thin to exhibit its hydrophobic and anti-ultraviolet functions, and will not have excessively low bonding force between oxide powder at the uppermost portion of the composite coating and the substrate due to excessive thickness, thereby preventing the oxide powder from easily falling off or wearing away.

In some preferred embodiments, in the composite coating, a mass ratio of the hydrophobically modified tetrapod-shaped zinc oxide powder to the hydrophobically modified nano metal oxide powder is 1:(1 to 5).

By controlling the mass ratio of the hydrophobically modified tetrapod-shaped zinc oxide powder to the hydrophobically modified nano metal oxide powder to be 1:(1 to 5), a large difference in feed amount between the two can be avoided, which would otherwise make it impossible to form an ideal micro-nano structure.

In some embodiments, the adhesive solution comprises an adhesive and a diluent in a mass ratio of 1:(1 to 3).

In some preferred embodiments, the diluent comprises one or more selected from ethyl acetate, acetone, n-hexane, dichloromethane, toluene, xylene, methanol, acetonitrile and silicone oil.

The diluents such as ethyl acetate, acetone, n-hexane, dichloromethane, toluene, xylene, methanol, acetonitrile and silicone oil can fully dissolve the one-component adhesive and adjust viscosity and curing rate of the one-component adhesive, so that the adhesive is suitable for spraying and for stepwise embedding of inorganic materials.

In some more preferred embodiments, the diluent comprises one or more selected from ethyl acetate, acetone, n-hexane and dichloromethane.

The diluents such as ethyl acetate, acetone, n-hexane and dichloromethane have relatively low toxicity and have little influence on human body after volatilization, and thus have high safety and will not cause environmental pollution.

In some embodiments, the substrate is one or more selected from a polymer substrate, a glass substrate, a ceramic substrate and a metal substrate.

It can be understood that the polymer substrate comprises one or more selected from an HTV silicone rubber substrate, an RTV silicone rubber substrate, a polyimide (PI) substrate, a polyethylene terephthalate (PET) substrate, a polycarbonate (PC) substrate and a polymethyl methacrylate (PMMA) substrate; the glass substrate comprises one or more selected from a quartz glass substrate, a sodium glass substrate, a potassium glass substrate, an alumino-magnesium glass substrate, a lead glass substrate and a borosilicate glass substrate; the ceramic substrate comprises one or more selected from an alumina substrate, a magnesia substrate, a zirconia substrate and an electrical porcelain substrate; and the metal substrate comprises one or more selected from a copper substrate, an aluminum substrate, a stainless steel substrate and a titanium alloy substrate.

The method of preparing the composite coating can select an appropriate adhesive according to material properties of the substrate, so as to form stable and firm bonding between the substrate and the composite coating, thereby exhibiting long-term hydrophobicity and anti-ultraviolet stability and having a wide range of applications.

In some preferred embodiments, the substrate is an HTV silicone rubber substrate.

When the substrate is HTV silicone rubber and the adhesive solution is a one-component RTV silicone rubber adhesive solution, strong adhesion can be obtained between the substrate and the composite coating due to very similar material properties, which is advantageous to improving long-term hydrophobicity and anti-ultraviolet performance of the composite coating.

According to a second aspect of the present disclosure, there is provided a composite coating prepared by the method of preparing the composite coating as described above.

According to a third aspect of the present disclosure, there is provided a silicone rubber protective sleeve comprising the composite coating as described above.

According to a fourth aspect of the present disclosure, there is provided an insulator comprising the silicone rubber protective sleeve as described above.

The disclosure will be further described in detail below with reference to specific embodiments.

### Example 1

(1) Referring to Table 1, 180 mL of ethanol and 10 mL of water were mixed, 5 g of tetrapod-shaped zinc oxide powder was added, and ultrasonic dispersion was performed for 30 minutes to obtain a dispersion. A total of 0.1 g of perfluorooctyltrichlorosilane was added into the dispersion, followed by uniform stirring to obtain a mixed solution. Sodium hydroxide was added to adjust the pH of the mixed solution to 8, and then the temperature was raised to 50° C., and the reaction was carried out under continuous stirring for 6 hours. After centrifugation, the resulting solid was washed three times successively with deionized water and absolute ethanol, and dried to obtain hydrophobically modified tetrapod-shaped zinc oxide powder.

(2) 180 mL of ethanol and 10 ml of water were mixed, 5 g of nano zinc oxide powder was added, and the nano zinc oxide powder was subjected to hydrophobic modification according to the method described in step (1) to obtain hydrophobically modified nano zinc oxide powder.

(3) A total of 1 g of one-component PRTV silicone rubber was mixed with 1 g of ethyl acetate for dilution, and stirred for 10 minutes to obtain a uniformly mixed adhesive solution. The adhesive solution was poured into a hopper of a pneumatic spray gun, and the adhesive solution was sprayed three times by means of the pneumatic spray gun so that the adhesive solution was uniformly coated on a surface of HTV silicone rubber, and the coated layer was preliminarily cured at room temperature for 3 minutes to obtain a liquid film having a thickness of 60 μm.

(4) The hydrophobically modified tetrapod-shaped zinc oxide powder was uniformly blown and sprinkled onto the surface of the liquid film, and a first curing was performed at room temperature for 10 minutes until the hydrophobically modified tetrapod-shaped zinc oxide powder was embedded, while the liquid film was not fully cured at this time. Loosely attached hydrophobically modified tetrapod-shaped zinc oxide powder on the surface of the liquid film was blown off, and a second curing was performed at room temperature for 5 minutes, at which time the liquid film was still not fully cured. The hydrophobically modified nano zinc oxide powder was uniformly blown and sprinkled onto the surface of the liquid film, and curing was then carried out at 60° C. for 8 hours to fully cure the liquid film. Loosely attached hydrophobically modified nano zinc oxide powder on the surface of the liquid film was blown off to obtain a composite coating having a micro-nano structure.

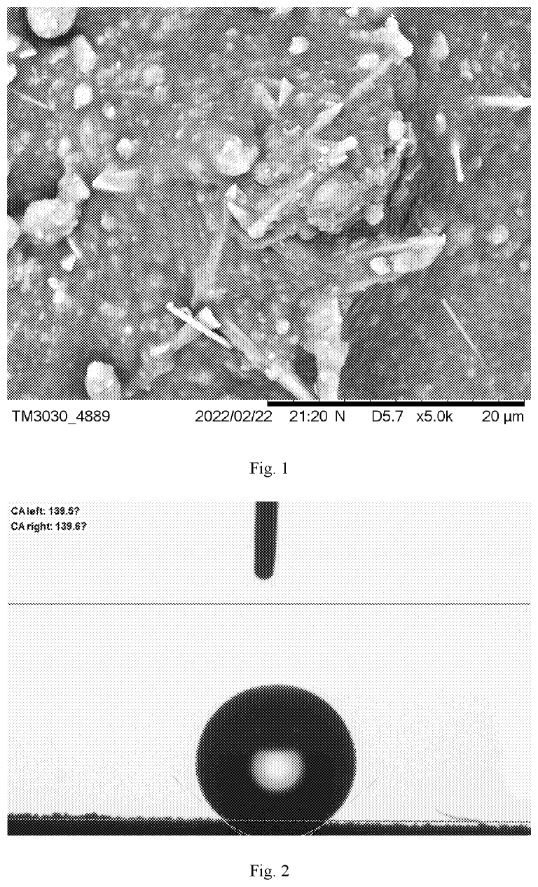

The micro-morphology of the composite coating was observed and photographed at a magnification of 5000× by SEM, and the result is shown in FIG. 1. With reference to GB/T 30693-2014 “Measurement of water-contact angle of plastic films”, the water contact angle of the composite coating was tested using a drop shape analyzer model DSA100 (KRÜSS, Germany), and the result is shown in FIG. 2. With reference to GB/T 531.1-2008 “Rubber, vulcanized or thermoplastic. Determination of indentation hardness. Part 1: Durometer method (Shore hardness)”, hardness data of the composite coating were tested using a Shore A durometer, and the results are shown in Table 2.

An anti-aging test was performed on the composite coating as follows. Under continuous irradiation of ultraviolet lamps, the water contact angle and hardness of the composite coating were tested at intervals, and the results are shown in Table 3. The conditions of ultraviolet lamp irradiation were as follows: six ultraviolet lamps having a power of 40 W and a wavelength of 315 nm to 400 nm were used to irradiate the composite coating for a long time.

### Example 2

(1) Referring to Table 1, 180 mL of ethanol and 10 ml of water were mixed, 10 g of tetrapod-shaped zinc oxide powder was added, and ultrasonic dispersion was performed for 30 minutes to obtain a dispersion. A total of 0.5 g of perfluorodecyltrimethoxysilane was added into the dispersion, followed by uniform stirring to obtain a mixed solution. Sodium hydroxide was added to adjust the pH of the mixed solution to 8, and then the temperature was raised to 60° C., and the reaction was carried out under continuous stirring for 5 hours. After centrifugation, the resulting solid was washed three times successively with deionized water and absolute ethanol, and dried to obtain hydrophobically modified tetrapod-shaped zinc oxide powder.

(2) 180 mL of ethanol and 10 ml of water were mixed, 10 g of nano zinc oxide powder was added, and the nano zinc oxide powder was subjected to hydrophobic modification according to the method described in step (1) to obtain hydrophobically modified nano zinc oxide powder.

(3) A total of 1 g of one-component PRTV silicone rubber was mixed with 2 g of acetone for dilution, and stirred for 10 minutes to obtain a uniformly mixed adhesive solution. The adhesive solution was poured into a hopper of a pneumatic spray gun, and the adhesive solution was sprayed three times by means of the pneumatic spray gun so that the adhesive solution was uniformly coated on a surface of HTV silicone rubber, and curing was performed at room temperature for 4 minutes to obtain a liquid film having a thickness of 60 μm.

(4) The hydrophobically modified tetrapod-shaped zinc oxide powder was uniformly blown and sprinkled onto the surface of the liquid film, and a first curing was performed at room temperature for 15 minutes until the hydrophobically modified tetrapod-shaped zinc oxide powder was embedded, while the liquid film was not fully cured at this time. Loosely attached hydrophobically modified tetrapod-shaped zinc oxide powder on the surface of the liquid film was blown off, and a second curing was performed at room temperature for 8 minutes, at which time the liquid film was still not fully cured. The hydrophobically modified nano zinc oxide powder was uniformly blown and sprinkled onto the surface of the liquid film, and curing was then carried out at 70° C. for 7 hours to fully cure the liquid film. Loosely attached hydrophobically modified nano zinc oxide powder on the surface of the liquid film was blown off to obtain a composite coating having a micro-nano structure.

The water contact angle and hardness data of the composite coating were tested according to the method described in Example 1, and the results are shown in Table 2.

### Example 3

(1) Referring to Table 1, 180 mL of ethanol and 10 ml of water were mixed, 20 g of tetrapod-shaped zinc oxide powder was added, and ultrasonic dispersion was performed for 30 minutes to obtain a dispersion. A total of 2 g of perfluorodecyltriethoxysilane was added into the dispersion, followed by uniform stirring to obtain a mixed solution. Sodium hydroxide was added to adjust the pH of the mixed solution to 8, and then the temperature was raised to 70° C., and the reaction was carried out under continuous stirring for 4 hours. After centrifugation, the resulting solid was washed three times successively with deionized water and absolute ethanol, and dried to obtain hydrophobically modified tetrapod-shaped zinc oxide powder.

(2) 180 mL of ethanol and 10 ml of water were mixed, 20 g of nano zinc oxide powder was added, and the nano zinc oxide powder was subjected to hydrophobic modification according to the method described in step (1) to obtain hydrophobically modified nano zinc oxide powder.

(3) A total of 1 g of one-component PRTV silicone rubber was mixed with 3 g of n-hexane for dilution, and stirred for 10 minutes to obtain a uniformly mixed adhesive solution. The adhesive solution was poured into a hopper of a pneumatic spray gun, and the adhesive solution was sprayed three times by means of the pneumatic spray gun so that the adhesive solution was uniformly coated on a surface of HTV silicone rubber, and curing was performed at room temperature for 5 minutes to obtain a liquid film having a thickness of 60 μm.

(4) The hydrophobically modified tetrapod-shaped zinc oxide powder was uniformly blown and sprinkled onto the surface of the liquid film, and a first curing was performed at room temperature for 20 minutes until the hydrophobically modified tetrapod-shaped zinc oxide powder was embedded, while the liquid film was not fully cured at this time. Loosely attached hydrophobically modified tetrapod-shaped zinc oxide powder on the surface of the liquid film was blown off, and a second curing was performed at room temperature for 10 minutes, at which time the liquid film was still not fully cured. The hydrophobically modified nano zinc oxide powder was uniformly blown and sprinkled onto the surface of the liquid film, and curing was then carried out at 80° C. for 6 hours to fully cure the liquid film. Loosely attached hydrophobically modified nano zinc oxide powder on the surface of the liquid film was blown off to obtain a composite coating having a micro-nano structure.

The water contact angle and hardness data of the composite coating were tested according to the method described in Example 1, and the results are shown in Table 2.

### Comparative Example 1

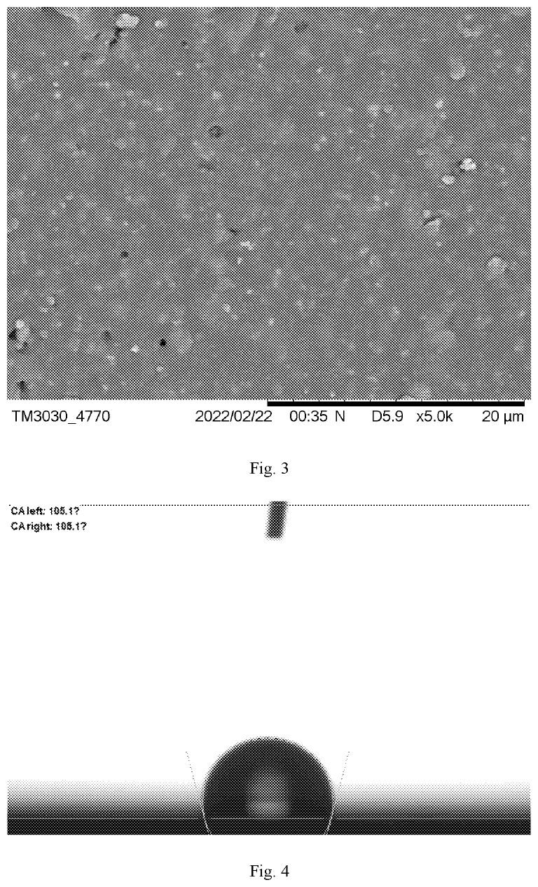

Comparative Example 1 is a blank control group, that is, no composite coating was prepared on the surface of the HTV silicone rubber. The micro-morphology of the HTV silicone rubber was observed and photographed at a magnification of 5000× by SEM, and the result is shown in FIG. 3. The water contact angle of the HTV silicone rubber was tested according to the method described in Example 1, and the result is shown in FIG. 4. Hardness data of the HTV silicone rubber were tested according to the method described in Example 1, and the results are shown in Table 2. The aging resistance of the HTV silicone rubber was tested according to the method described in Example 1, and the results are shown in Table 3.

TABLE 1
Parameters of raw materials in Examples 1-3 and Comparative Example 1

| Raw material | | Supplier | Grade/Model | Parameter |
|---|---|---|---|---|
| Tetrapod-shaped zinc oxide powder | | Chengdu | / | Central body |
| | | Jiaoda Jingyu | | diameter 1 μm |
| | | Technology | | to 10 μm, |
| | | Co., Ltd. | | whisker length |
| | | | | 10 μm to |
| | | | | 100 μm |
| Nano metal | Nano zinc oxide powder | Shanghai | / | Particle |
| oxide | | Aladdin | | size ≤100 nm |
| powder | | Biochemical | | |
| | | Technology | | |
| | | Co., Ltd. | | |
| Silane | Perfluorooctyltrichlorosilane | Shanghai | AR | |
| coupling | | Aladdin | | |
| agent | | Biochemical | | |
| | | Technology | | |
| | | Co., Ltd. | | |
| | Perfluorodecyltrimethoxysilane | Shanghai | AR | |
| | | Aladdin | | |
| | | Biochemical | | |
| | | Technology | | |
| | | Co., Ltd. | | |
| | Perfluorodecyltriethoxysilane | Shanghai | AR | |
| | | Aladdin | | |
| | | Biochemical | | |
| | | Technology | | |
| | | Co., Ltd. | | |
| One- | One-component PRTV silicone | Hebei | None | Curing |
| component | rubber | Guangbei | | conditions: ≥24 |
| adhesive | | Electric | | h at room |
| | | Power | | temperature; 6 |
| | | Technology | | h to 8 h at |
| | | | | 60° C. to 80° C. |
| Diluent | Ethyl acetate | Sinopharm | AR | |
| | | Chemical | | |
| | | Reagent Co., | | |
| | | Ltd. | | |
| | Acetone | Sinopharm | AR | |
| | | Chemical | | |
| | | Reagent Co., | | |
| | | Ltd. | | |
| | N-hexane | Sinopharm | AR | |
| | | Chemical | | |
| | | Reagent Co., | | |
| | | Ltd. | | |
| Substrate | HTV silicone rubber | Aimosen | FXBW4-35 | |

TABLE 2
Performance test results of composite coatings
in Examples 1-3 and Comparative Example 1

| | | | Contact | Hardness/ |
|---|---|---|---|---|
| | | Morphology | angle/° | HA |
| Example | 1 | Micro-nano structure | 151.1 | 68.5 |
| | 2 | having a lotus-leaf- | 150.2 | 68.0 |
| | 3 | like papillary structure | 150.7 | 68.5 |
| Comparative | 1 | No micro-nano | 105.1 | 64.5 |
| Example | | structure having a | | |
| | | lotus-leaf-like | | |
| | | papillary structure | | |

TABLE 3
Anti-aging test results of composite coating
in Example 1 and Comparative Example 1

| Test | Example 1 | | Comparative Example 1 | |
|---|---|---|---|---|
| time | Water contact | Hardness/ | Water contact | Hardness/ |
| (h) | angle/° | HA | angle/° | HA |
| 0 | 151.1 | 68.5 | 105.1 | 64.5 |
| 500 | 149.0 | 69.5 | 102.3 | 67.5 |
| 900 | 140.2 | 70.0 | 90.7 | 70.5 |

From FIG. 1 it can be seen that the composite coating in Example 1 has a micro-nano structure having a lotus-leaf-like papillary structure, whereas the surface of the HTV silicone rubber in FIG. 3 is flat and does not have a micro-nano structure. As can be seen from Table 2, the water contact angle of the composite coatings in Examples 1-3 can reach 151.1°, whereas the water contact angle of the HTV silicone rubber in Comparative Example 1 is only 105.1°. This indicates that, compared with unmodified HTV silicone rubber, the composite coating having a micro-nano structure can significantly improve hydrophobicity of the HTV silicone rubber substrate.

As can be seen from Table 3, after 900 hours of ultraviolet irradiation, the water contact angle of the composite coating of Example 1 is still 140.2°, and the relative reduction amplitude is only 7.21%, whereas the relative reduction amplitude of Comparative Example 1 reaches 13.70%. This indicates that the composite coating of Example 1 not only has more excellent hydrophobicity, but also does not exhibit obvious deterioration in hydrophobicity after long-term ultraviolet irradiation, thus exhibiting good long-term hydrophobicity. At the same time, after 900 hours of ultraviolet irradiation, the hardness of the composite coating of Example 1 increases from 68.5 HA to 70.0 HA, with a relative increase amplitude of 2.19%, whereas the relative increase amplitude of Comparative Example 1 reaches 9.30%. This indicates that, as ultraviolet aging time increases, the hardness of the composite coating changes insignificantly, and its anti-ultraviolet performance is more stable. In addition, the composite coating is firmly attached and not easy to detach, and the water contact angle changes only slightly after the ultraviolet aging test, which can also indirectly demonstrate that the composite coating has very excellent anti-ultraviolet stability.

In summary, the composite coating having a micro-nano structure can greatly improve long-term hydrophobicity and anti-ultraviolet stability of the substrate, thereby exhibiting excellent anti-aging effect.

The technical features in the above-described embodiments may be arbitrarily combined. For the sake of concise description, all possible combinations of the technical features in the above embodiments are not described exhaustively in the present description. However, as long as there is no contradiction among the technical features, such combinations shall be deemed as falling within the scope recorded in the present specification.

The above-described embodiments merely illustrate several embodiments of the present disclosure and are described in a relatively specific and detailed manner, but they should not be construed as limiting the scope of the present disclosure. It should be noted that, for those of ordinary skill in the art, various modifications and improvements can be made without departing from the concept of the present disclosure, and these all fall within the scope of protection of the present disclosure. Therefore, the scope of protection of the present disclosure shall be subject to the appended claims.

What is claimed is:

1. A method of preparing a composite coating, comprising:
coating an adhesive solution on a substrate to obtain a liquid film; and
embedding hydrophobically modified tetrapod-shaped zinc oxide powder into a surface of the liquid film and then embedding hydrophobically modified nano metal oxide powder into the surface of the liquid film, and fully curing the liquid film to obtain a composite coating having a micro-nano structure.

2. The method according to claim 1, wherein the nano metal oxide powder comprises one or more of nano zinc oxide powder, nano titanium oxide powder, nano cerium oxide powder and nano iron oxide powder.

3. The method according to claim 1, wherein the adhesive solution is a one-component room temperature vulcanized (RTV) silicone rubber adhesive solution.

4. The method according to claim 3, wherein embedding the hydrophobically modified tetrapod-shaped zinc oxide powder into the surface of the liquid film comprises:
sprinkling the hydrophobically modified tetrapod-shaped zinc oxide powder onto the surface of the liquid film, and subjecting the liquid film to a first curing at room temperature until the hydrophobically modified tetrapod-shaped zinc oxide powder is embedded while the liquid film is not fully cured; and
removing the hydrophobically modified tetrapod-shaped zinc oxide powder that has not been embedded in the surface of the liquid film.

5. The method according to claim 3, wherein the liquid film is fully cured at a temperature of 60° C. to 80° C. for 6 to 8 hours.

6. The method according to claim 1, wherein the hydrophobically modified tetrapod-shaped zinc oxide powder and the hydrophobically modified nano metal oxide powder are prepared by a coupling modification method.

7. The method according to claim 6, wherein a method of preparing the hydrophobically modified tetrapod-shaped zinc oxide powder comprises:
mixing tetrapod-shaped zinc oxide powder with ethanol and water to obtain a dispersion;
adding a silane coupling agent into the dispersion to obtain a mixed solution; and
adjusting a pH of the mixed solution to 7 to 9, stirring at 50° C. to 70° C. for 4 to 6 hours, and subjecting the mixed solution to solid-liquid separation to obtain the hydrophobically modified tetrapod-shaped zinc oxide powder.

8. The method according to claim 6, wherein a method of preparing the hydrophobically modified nano metal oxide powder comprises:
mixing nano metal oxide powder with ethanol and water to obtain a dispersion;
adding a silane coupling agent into the dispersion to obtain a mixed solution; and
adjusting a pH of the mixed solution to 7 to 9, stirring at 50° C. to 70° C. for 4 to 6 hours, and subjecting the mixed solution to solid-liquid separation to obtain the hydrophobically modified nano metal oxide powder.

9. The method according to claim 7, wherein the method of preparing the hydrophobically modified tetrapod-shaped zinc oxide powder and the hydrophobically modified nano metal oxide powder satisfies one or more of the following conditions:
(1) the silane coupling agent is a perfluoro silane coupling agent;
(2) a mass ratio of the silane coupling agent to the tetrapod-shaped zinc oxide powder or the nano metal oxide powder is (1 to 10): 100;
(3) a concentration of the tetrapod-shaped zinc oxide powder or the nano metal oxide powder in the dispersion is 1 wt. % to 12 wt. %; and
(4) a volume ratio of the ethanol to the water is (1 to 9): 1.

10. The method according to claim 1, wherein the composite coating satisfies one or more of the following conditions:
(1) a whisker length of the tetrapod-shaped zinc oxide powder is 10 μm to 100 μm;
(2) a particle size of the nano metal oxide powder is ≤100 nm;
(3) a thickness of the liquid film is 50 μm to 70 μm; and
(4) a thickness of the composite coating is 80 μm to 100 μm.

11. The method according to claim 1, wherein the adhesive solution comprises an adhesive and a diluent in a mass ratio of 1:(1 to 3).

12. The method according to claim 1, wherein the substrate is one or more selected from a polymer substrate, a glass substrate, a ceramic substrate and a metal substrate.
